(19) United States
(12) Patent Application Publication
(10) Pub. No.: US 2014/0357486 A1
(43) Pub. Date: Dec. 4, 2014

(54) Herbicide and Fertilizer

(71) Applicant: D & J Akers Pty Ltd, Onkaparinga Hills (AU)

(72) Inventor: Bradley Alan Akers, Morphett Vale (AU)

(73) Assignee: D & J Akers Pty Ltd, Onkaparinga Hills (AU)

(21) Appl. No.: 14/287,780

(22) Filed: May 27, 2014

(30) Foreign Application Priority Data
May 28, 2013 (AU) 2013901894

(51) Int. Cl. C05G 3/02; A01N 37/38; A01N 43/40

(52) U.S. Cl. CPC C05G 3/02; A01N 43/40; A01N 37/38
USPC 504/130

(57) ABSTRACT

Compositions comprising a herbicidally effective amount of at least one Group I herbicide, a herbicidally effective amount of at least one Group F herbicide, and a seaweed extract and/or fish extract. The compositions are used for weed control, fertilizing, and soil conditioning. Provided the Group I and Group F herbicides and the seaweed extract or fish extract are organic with minimal or no inorganic content, the components do not interfere with one another in terms of their function.

### FIELD OF THE INVENTION

The present invention relates to herbicidal compositions, and to methods of using such compositions to selectively kill, or control the growth and proliferation of, weeds.

### CROSS-REFERENCE TO RELATED APPLICATION

This application claims priority to Australian Patent Application No. 2013901894, filed on May 28, 2013, the entirety of which is incorporated herein by reference.

### BACKGROUND OF THE INVENTION

Herbicides are commonly used to protect crops, lawns, turf and the like (i.e. cultivated plants) from weeds (i.e. any unwanted plant). Non-selective herbicides kill all plant material with which they come into contact and, hence, are not suitable for use when weeds are growing amongst cultivated plants. Glyphosate is a commonly used non-selective herbicide.

Selective herbicides kill specific target weeds while leaving cultivated plants relatively unharmed. For example, selective herbicides are commonly used to kill broadleaf weeds in lawns and turf. 2,4-Dichlorophenoxyacetic acid (“2,4-D”) kills many broadleaf weeds while leaving grasses largely unaffected and it remains one of the most commonly used selective herbicides.

Herbicides can be used prior to planting (i.e.“pre-emergent” use) to rid an area to be planted of weeds and/or to prevent growth of weeds in the area. Additionally, there is often a need to treat an area after planting (i.e. “post-emergent” use) so as to prevent weed growth in the early stages of plant establishment. Furthermore, there is often a need to apply a fertilizer to an area to be planted prior to planting in order to enrich the soil with nutrients that are essential for plant growth. This need typically also extends for a period after planting so that the nutrient profile in the soil remains optimal during plant establishment. The application of pre-emergent and post-emergent herbicide and fertilizer treatments can be time consuming, particularly on a commercial scale such as in the establishment of lawns in parks, golf courses or sporting fields.

Combination herbicide and fertilizer products that are generally sold using the term “Weed 'n Feed” are now in widespread use in the turf and lawn industries and are designed to kill weeds and fertilize the grass in a single application. The convenience of use has made these combination products among the most frequently used lawn care products. Most Weed 'n Feed herbicide/fertilizer products use a high nitrogen water soluble fertilizer which encourages top growth but does little for the overall health and vigor of a plant.

There is a need for herbicide/fertilizer products that overcome one or more of the problems associated with known products and/or provide a useful alternative to known products.

### SUMMARY OF THE INVENTION

In a first aspect, the present invention provides a composition comprising a herbicidally effective amount of at least one Group I herbicide, a herbicidally effective amount of at least one Group F herbicide, and a seaweed extract and/or fish extract.

The composition is used for weed control, fertilizing, and soil conditioning. Provided the Group I and Group F herbicides and the seaweed extract or fish extract are organic with minimal or no inorganic content, the components do not interfere with one another in terms of their function.

In some embodiments, the composition further comprises a humectant.

In some embodiments, the composition further comprises one or more macro- or micronutrients.

In some embodiments, the composition further comprises a pH adjusting agent to adjust the pH of the composition to from about pH 6 to about pH 8.

In some embodiments, the Group F herbicide is a nicotinanilide. In specific embodiments, the Group F herbicide is diflufenican.

In some embodiments, the Group I herbicide is a phenoxy. In specific embodiments, the Group I herbicide is a salt of 2-methyl-4-chlorophenoxyacetic acid (MCPA). In embodiments, the salt is a potassium salt.

In some embodiments, the Group I herbicide is a pyridine. In specific embodiments, the Group I herbicide is clopyralid potassium salt.

The composition may comprise more than one Group F herbicide and/or more than one Group I herbicide. In embodiments, the composition comprises two Group I herbicides. In specific embodiments, the two Group I herbicides are the potassium salt of MCPA and clopyralid potassium salt.

Advantageously, the composition can be used for the selective control of broadleaf weeds in crops of cultivated plants and also as a fertilizer for the cultivated plants. The composition is especially suitable for the control of broadleaf weeds in lawns, grasses and turf.

In a second aspect, the present invention provides a method for killing or controlling the growth of undesirable vegetation, the method comprising contacting the foliage of the undesirable vegetation with a herbicidally effective amount of composition of the first aspect of the invention.

In a third aspect, the present invention provides the use of a composition of the first aspect of the invention for killing or controlling the growth of undesirable vegetation.

In embodiments of the second and third aspects of the invention, the composition is used for the selective killing or control of undesirable vegetation in crops of cultivated plants. For example, the composition can be used to kill or control the growth of broadleaf weeds in turf or lawn.

### DETAILED DESCRIPTION OF THE INVENTION

The present invention is the result of research the applicant has carried out into compositions that can be used to selectively control weeds in lawn and turf and also fertilize the lawn and turf. The research has shown that a combination of particular herbicides and fertilizer components provides a composition that not only selectively kills weeds but also promotes growth of cultivated lawn and turf, improves soil characteristics and deters pests such as African Black Beetle.

The present invention provides a composition comprising a herbicidally effective amount of at least one Group I herbicide, a herbicidally effective amount of at least one Group F herbicide, and a seaweed extract and/or fish extract.

The amounts of components in the compositions of the present invention are given in units of Vol %, g/L (i.e. grams per liter), or w/v %. Unless otherwise indicated, the amounts given are in relation to a final, ready-to-use or diluted composition. The skilled person will understand that the compositions may be available as concentrates in which the percentage amounts of each component of the composition are higher than they are in the diluted composition and reference to specific amounts herein is not to be taken to limit the scope of the invention to those specific amounts.

The composition can be used as a pre-emergent herbicide, soil conditioner and/or pest deterrent or as a post-emergent selective herbicide, soil conditioner and/or pest deterrent. The composition is particularly useful for the control of broadleaf weeds in lawns and turf. However, it will be appreciated that the composition can also be applied in other cultivated plants, such as fruit and vegetable crops, ornamental plants, etc.

The composition can be used to kill or control the growth of weeds in a wide variety of grasses including, but not limited to, buffalo, kikuyu, couch, and fescue. In trials, during spraying the composition was seen to drift onto surrounding native grasses and vegetations, with no impact.

The composition may be used to kill or control the growth of weeds including, but not limited to, white clover, plantain, capeweed, cat's ear, bindii, cudweed, creeping oxalis, wild radish, hedge mustard, Indian hedge mustard, wild turnip, turnip weed, charlock, deadnettle, prickly lettuce, pheasants eye, crassula, corn gromwell, marshmallow, shepherd's purse, chickweed, hyssop loosestrife, mouse-eared chickweed, nigh-scented stock, skeleton weed, speedwell, amsinckia, wireweed, Peterson's curse (Salvation Jane), rough poppy, sorrel, toad rush, stinging nettle, fat hen, noogoora burr, saffron thistle, creeping thistle, cape ivy, groundsel bush, knapweed, and silver wattle. The composition has also been seen to have an impact on sour sob (Oxalis pes-caprae) although it may not necessarily kill that plant because it is bulbous. However, when introduced into a properly managed Integrated Pest Management (IPM) plan, including weekly mowing practices and organic granular applications of fertilizer, sour sob bulbs will be exhausted, and hence are killed successfully.

As used herein, the terms “Group I herbicide” and “Group F herbicide” refer to herbicides that are classified according to the herbicidal mode of action as determined by CropLife Australia and available at www.croplifeaustralia.org.au.

Group F herbicides are inhibitors of carotenoid biosynthesis. They interfere with enzymes in the plant that synthesise carotenoids thereby leading to destruction of chlorophyll and disruption of cell membranes. Group F herbicides are selective, translocated and are taken up by roots and leaves. In embodiments, the Group F herbicide in the composition is selected from one or more of the group consisting of: a nicotinanilide, a picolinaminde, and a pyridazinone. In some embodiments, the Group F herbicide is a nicotinanilide. In specific embodiments, the Group F herbicide is diflufenican (N-(2,4-difluorfenyl)-2-[3- (trifluormethyl)fenoxy]-3-pyridinecarboxamide). The diflufenican may be present in a final composition in an amount of from about 0.01 to about 30 g/L. In embodiments, the diflufenican is present in the final composition in an amount of from about 0.04 to about 0.1 g/L. In specific embodiments, the diflufenican is present in the final composition in an amount of about 0.06 g/L.

Group I herbicides act as auxins or plant growth hormones and produce rapid, uncontrolled growth, with existing leaves twisting or curling, new leaves failing to form or forming abnormally, and stems thickening. Group I herbicides are taken up by the leaves, (and roots by the picolinic and benzoic acids), translocated, and are selective.

In embodiments, the Group I herbicide in the composition of the present invention is selected from one or more of the group consisting of: a phenoxy (phenoxycarboxylic acid), a benzoic acid, a pyridine (pyridinecarboxylic acid), and a quinolinecarboxylic acid. In some embodiments, the Group I herbicide is a phenoxy. Suitable phenoxys include: 2,4-dichlorophenoxyacetic acid (2,4-D); 2,4-dichlorophenoxybutyric acid (2,4-DB); 2-(2,4-dichlorophenoxy)propionic acid (dichlorprop, 2,4-DP); 2-methyl-4-chlorophenoxyacetic acid (MCPA); 4-(4-chloro-2-methylphenoxy)butanoic acid (MCPB); and 2-(2-methyl-4-chlorophenoxy)propionic acid (mecoprop, MCPP).

In specific embodiments, the Group I herbicide is a salt of 2-methyl-4-chlorophenoxyacetic acid (MCPA). In embodiments, the salt is a potassium salt. The MCPA potassium salt may be present in the final composition in an amount of from about 0.5 to about 400 g/L. In embodiments, the MCPA potassium salt is present in the final composition in an amount of from about 0.5 to about 5 g/L. In specific embodiments, the MCPA potassium salt is present in the final composition in an amount of about 1.1 g/L.

In some embodiments, the Group I herbicide is a pyridine. In specific embodiments, the Group I herbicide is clopyralid potassium salt. The clopyralid potassium salt may be present in the final composition in an amount of from about 0.05 to about 30 g/L. In embodiments, the clopyralid potassium salt is present in the final composition in an amount of from about 0.05 to about 0.2 g/L. In specific embodiments, the clopyralid potassium salt is present in the final composition in an amount of about 0.08 g/L.

The composition may comprise more than one Group F herbicide and/or more than one Group I herbicide. In embodiments, the composition comprises two Group I herbicides. In specific embodiments, the two Group I herbicides are the potassium salt of MCPA and clopyralid potassium salt.

Thus, in some embodiments the composition comprises diflufenican, MCPA potassium salt, and clopyralid potassium salt.

The composition also contains seaweed extract and/or fish extract which function as fertilizer and soil conditioners. The seaweed extract may be a kelp extract. A range of seaweed extracts and fish extracts are available commercially and can be used in the composition of the present invention. For example, the product available under the trade name VITAPLANT from Baileys Fertilisers, Western Australia contains kelp and seaweed extract and is suitable for use in the composition of the present invention. Other suitable products include fish hydrosylate produced by SAMPI, South Australia, Australia. The seaweed extract and/or fish extract may be present in the final composition in an amount of from about 1 vol % to about 50 vol %. In embodiments, the seaweed extract and/or fish extract is present in the final composition in an amount of from about 1 vol % to about 10 vol %. In specific embodiments, the seaweed extract and/or fish extract is present in the final composition in an amount of about 5 vol %.

Seaweed and kelp extracts may contain cytokinins, auxins, gibberellins (i.e plant hormones), vitamins and enzymes which may improve rooting, turf health, foliar growth, disease management, pest management, and/or environmental stress resistance. Fish hydrosylate is produced by enzymatic digestion of fishguts, bones, cartilage, scales, meat, etc. and may contain proteins, amino acids, vitamins and trace elements. Seaweed extracts and fish extracts contain natural chelating agents that make nutrients immediately available to plants and also stimulate soil microbes. We have also found that they tend to deter pests such as African Black Beetle.

The kelp extract, seaweed extract, fish extract or fish hydrosylate may naturally contain macro- and micro-nutrients. Alternatively, the composition of the present invention may further comprise one or more added macro- or micro-nutrients. The macronutrients may be selected from nitrogen (N), phosphorus (P), potassium (K), calcium (Ca), magnesium (Mg), and sulfur (S), whilst the micronutrients may be selected from boron (B), chlorine (Cl), copper (Cu), iron (Fe), manganese (Mn), molybdenum (Mo), zinc (Zn) and nickel (Ni). For example, the composition may contain nitrogen in the form of urea, phosphorus in the form of mono ammonium phosphate, potassium in the form of a potassium salt such as potassium nitrate and/or magnesium in the form of a magnesium salt such as magnesium sulphate. The composition may also contain boron in the form of borax, copper in the form of a copper salt such as copper sulphate, iron in the form of an iron salt such as iron sulphate, manganese in the form of a manganese salt such as manganese sulphate, and/or zinc in the form of a zinc salt such as zinc sulphate.

The macronutrients may each be present in the final composition in amounts of about 0.01 g/L to about 20 g/L. In some embodiments, the final composition contains about 1 to about 10 g/L N. In some embodiments, the final composition contains about 0.5 to about 5 g/L P. In some embodiments, the final composition contains about 1 to about 10 g/L K. A final composition comprising about 5.7 g/L N, about 1 g/L P and about 4 g/L K may be particularly suitable.

The final composition may additionally comprise about 0.2 g/L Fe, about 0.3 g/L Mn and about 2 g/L S.

In some embodiments, the composition further comprises a humectant. The humectant may be any material that attracts and/or retains moisture in the soil when it is applied to the soil. Suitable humectants are hygroscopic materials including magnesium sulphate; polyhydric alcohols such as ethylene glycol, propylene glycol, butanediol, glycerol and pentaerythritol, and their ethers and esters, for example ethylene, glycol ethers, propylene glycol ethers or glycerol esters; polyalkylene glycols such as polyethylene glycols, polypropylene glycols and ethylene oxide (EO)/propylene oxide (PO) copolymers, for example with EO-PO-, EO-PO-EO- or PO-EO-PO units; sugars such as hexoses, pentoses, molasses, alkylpolysaccharides and xanthans; gelatin; cellulose derivatives such as water-soluble lignosulfonates or hydroxycelluloses; citric acid and citric acid derivatives such as citric acid salts, for example alkali metal, alkaline earth metal or ammonium citrates, such as sodium citrate; lactic acid and lactic acid derivatives such as lactic acid salts, for example alkali metal, alkaline earth metal or ammonium lactates, such as sodium lactate; tartaric acid and tartaric acid derivatives such as tartaric acid salts, for example alkali metal, alkaline earth metal or ammonium tartrates such as sodium tartrate; aspartic acid and aspartic acid derivatives such as aspartic acid salts, for example alkali metal, alkaline earth metal or ammonium aspartates such as sodium aspartate; succinates; polyvinyl compounds such as modified polyvinylpyrrolidone or the derivatised polyvinyl acetates or the polyvinyl butyrates or the modified polyvinyl alcohols.

The pH of the composition is preferably in the range of from about pH 6 to about pH 8. We have found that optimal results are obtained when the composition is in this pH range. In some instances, the water used to prepare or dilute the composition may be alkaline and the composition may further comprise a pH adjusting agent to adjust the pH of the composition to from about pH 6 to about pH 8. This may be the case, for example, with municipal water. In these cases, the pH adjusting agent may be an acid. We have found that the product commercially available under the trade name Supa Link™ by AgriChem is suitable for this purpose. Supa Link™ may be added to the composition at a rate of 300 ml/100 L of diluted mixture. In other cases, the water used to prepare or dilute the composition may be acidic and the composition may further comprise a pH adjusting agent to adjust the pH of the composition to from about pH 6 to about pH

Optionally, the composition may also contain one or more adjuvants or additives. Adjuvants can include surfactants and/or inorganic salts with the aim of further enhancing herbicidal efficacy. Additives can include dyes which can provide the user with a visual marking of the area that has been sprayed to thereby minimise spray overlap.

The composition may be a liquid solution which is applied to foliage of cultivated plants and simultaneously to foliage of weeds by spraying, using any conventional means for spraying liquids, such as spray nozzles, atomizers or the like.

Alternatively, the composition may be two phase liquid composition having an aqueous phase containing water soluble herbicides and components, and a non-aqueous phase containing herbicides and components that are relatively water-insoluble. Such formulations include emulsions (including macro- and microemulsions, water-in-oil, oil-in-water and water- in-oil-in-water types), and suspensions.

Liquid or emulsion compositions will normally contain a suitable solvent or carrier. Preferably, the solvent is water or an aqueous solvent. The composition may be a concentrate which is diluted with water prior to or during application. Such compositions are typically referred to as “tank-mix” compositions. Alternatively, the composition may be a ready to use composition containing water.

Seaweed extracts and fish extracts are typically produced as aqueous solutions and, therefore, the compositions of the present invention will typically be liquids or emulsions. Nevertheless, it is contemplated that the composition could also be in the form of a gel, solid, powder, tablet or the like. For example, seaweed extracts and/or fish extracts can be dried to provide a powdered extract which can then be mixed, in the desired proportions, with a solid Group I herbicide and a solid Group F herbicide and other optional ingredients to produce a solid or powdered composition. The solid or powdered composition can be reconstituted as required by adding water or other aqueous compositions, as required. The solid or powdered composition could also be pressed into tablet form or similar using standard techniques.

The person skilled in the art will know that various factors influence the application rate of the composition, including individual plant conditions, weather and growing conditions, as well as the specific active ingredients and their weight ratio in the composition.

The present invention is also directed to a method for killing or controlling the growth of undesirable vegetation, the method comprising contacting the foliage of the undesirable vegetation with a herbicidally effective amount of the composition of the present invention.

The present invention provides the use of a composition of the present invention for killing or controlling the growth of undesirable vegetation.

As described previously, the composition can be used for the selective killing or control of undesirable vegetation in crops of cultivated plants. For example, the composition can be used to kill or control the growth of broadleaf weeds in turf or lawn.

Advantageously, the applicant has found that synergistic benefits are gained by adding together the components of the composition of the invention. For example, the composition improves soil structure by promoting growth of natural microbes and worms in the soil whilst also deterring African Black Beetle and other unwanted pests.

### EXAMPLE

5.5 L of VitaPlant™ (Baileys Fertilisers, Western Australia, Australia), 400 mL Bow & Arrow™ (Turfcare Solutions, Queensland, Australia) or alternative when chemicals are added individually, and 300 mL Supa Link™ (AgriChem, Queensland, Australia) were added to 100 L of water. The ingredients were added to a tanker as it was being filled with water which causes agitation to occur. 100 mL of dye (EnviroDye supplied by Landmark) per 100 L was also added to the mixture.

The Bow & Arrow™ composition used in preparing the composition of the present invention comprised 20 g/L clopyralid potassium salt, 15 g/L diflufenican and 300 g/L of the potassium salt of 2-methyl-4-chlorophenoxyacetic acid.

The final composition is shown in the following Table.

| Component | Amount | |
|---|---|---|
| 2-Methyl-4-chlorophenoxyacetic | 1.1 | g/L. |
| acid (MCPA) potassium salt | | |
| Diflufenican | 0.06 | g/L |
| Clopyralid potassium salt | 0.08 | g/L |
| Kelp extract | 5 | vol % |
| Nitrogen | 5.7 | g/L |
| Phosphorous | 1 | g/L P |
| Potassium | 4 | g/L |
| Iron | 0.2 | g/L |
| Manganese | 0.3 | g/L |
| Sulfur | 2 | g/L |

The composition is suitable for spraying onto an area to be treated.

The active constituents could also be added to a shuttle (1000 L) device, without water, at various concentrations for use.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

We claim:

1. A composition comprising a herbicidally effective amount of at least one Group I herbicide, a herbicidally effective amount of at least one Group F herbicide, and seaweed extract and/or fish extract.

2. The composition according to claim 1, further comprising a humectant.

3. The composition according to claim 1, further comprising one or more macro- or micronutrients.

4. The composition according to claim 1, further comprising a pH adjusting agent in an amount to adjust the pH of the composition to from about pH 6 to about pH 8.

5. The composition according to claim 1, wherein the Group F herbicide is a nicotinanilide.

6. The composition according to claim 5, wherein the Group F herbicide is diflufenican.

7. The composition according to claim 5, wherein the Group I herbicide is a phenoxy.

8. The composition according to claim 7, wherein the Group I herbicide is a salt of 2-methyl-4-chlorophenoxyacetic acid (MCPA).

9. The composition according to claim 8, wherein the salt is a potassium salt.

10. The composition according to claim 5, wherein the Group I herbicide is a pyridine.

11. The composition according to claim 10, wherein the Group I herbicide is clopyralid potassium salt.

12. The composition according to claim 1, comprising more than one Group F herbicide and/or more than one Group I herbicide.

13. The composition according to claim 12, wherein the composition comprises two Group I herbicides.

14. The composition according to claim 13, wherein the two Group I herbicides are the potassium salt of MCPA and clopyralid potassium salt.

15. A method for killing or controlling the growth of undesirable vegetation, the method comprising contacting the foliage of said undesirable vegetation with a herbicidally effective amount of the composition according to claim 1.

16. Use of a composition according to claim 1 for killing or controlling the growth of undesirable vegetation.

17. A composition comprising:
a) 0.5 g/L to 5 g/L of the potassium salt of 2-methyl-4-chlorophenoxyacetic acid;
b) 0.05 g/L to 0.2 g/L of clopyralid potassium salt;
c) 0.04 g/L to 0.1 g/L of diflufenican;
d) 0.001 vol % to 0.01 vol % of a pH adjusting agent;
e) 1 vol % to 10 vol % of a seaweed extract and/or fish extract; and
f) water to volume.

18. The composition according to claim 17, further comprising 1 to 10 g/L N, 0.5 to 5 g/L P, and 1 to 10 g/L K.

19. The composition according to claim 18, further comprising 0.2 g/L Fe, 0.3 g/L Mn, and 2 g/L S.
